(19) United States
(12) Patent Application Publication
(10) Pub. No.: US 2007/0233525 A1
(43) Pub. Date: Oct. 4, 2007

(54) Methods and systems for adjudication and processing of claims

(75) Inventor: Margaret A. Boyle, Wauwatosa, WI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metavante Corporation, Milwaukee, WI (US)

(21) Appl. No.: 11/396,235

(22) Filed: Mar. 31, 2006

(51) Int. Cl. G06Q 10/00; G06Q 40/00

(52) U.S. Cl. 705/4; 705/2; 705/40

(57) ABSTRACT

Methods and systems process a request for reimbursement of an expense incurred from a service provider by a customer. A first electronic packet having the reimbursement request is received at a coordination system. The reimbursement request includes an identification of the customer, an identification of a reimbursement-account provider, and a reimbursement amount. A second electronic packet is transmitted from the coordination system to a provider platform maintained by or on behalf of the reimbursement-account provider. The second electronic packet includes the identification of the customer, the reimbursement amount, and information related to a service provided for the customer by the service provider. A third electronic packet is received from the provider platform at the coordination system. The third electronic packet comprises an approval of the reimbursement request. Instructions are issued with the coordination system to effect payment for the service by the reimbursement-account provider.

### BACKGROUND OF THE INVENTION

This application relates generally to claims processing. More specifically, this application relates to methods and systems for adjudication and processing of claims.

It is well known that the cost of medical services has been increasing rapidly in the last several years, outpacing the general rate of inflation by a significant amount. A part of a response to this concern has been to provide finding vehicles for medical services that enjoy certain tax advantages, enabling customers of those services to pay for them in a more economical way. Similar types of funding vehicles have also been developed for other types of services that policy-makers have identified as of sufficient importance to enjoy similar benefits.

In the United States, a number of different types of tax-sheltered accounts have been authorized. The various accounts available include health savings accounts (“HSAs”), flexible spending accounts (“FSAs”), health-reimbursement accounts (“HRAs”), dependent-care reimbursement accounts (“DCRAs”), transportation reimbursement accounts (“TRAs”), parking reimbursement accounts (“PRAs”), and the like. While there are certain features that are common to these various types of accounts, they also have separate compliance rules that must be met for funds to be recovered from them.

The similarities among these accounts are generally grounded in their nature as accounts that are funded by periodic deductions from wages paid to employees. Such deductions are applied before the calculation of income taxes, acting to reduce the effective income on which participants are taxed. Funds in accounts may be recovered when eligible expenses have been incurred by the participants. The ways in which the various types of accounts differ not only include differences in the particulars of the types of expenses that qualify for reimbursement but also include differences in the types of proof needed to show that qualifying expenses have been incurred. Furthermore, specific requirements may vary among different providers that manage such accounts. The need to comply with different requirements for different accounts is not only frustrating for employees, but acts as an inhibition to taking full advantage of the benefits that such accounts may provide. This inhibition is exacerbated by the fact that providers of such accounts change relatively frequently, whether such changes be a result of changes effected by employers or a result of job changes by employees. In addition, the changes in providers result in records for employees that are fractured among multiple providers, some of whom no longer provide access to records because the prior relationship with the employee has been severed. This makes it difficult for employee participants in such accounts to monitor their histories with their accounts effectively.

For these various reasons, there is a general need in the art for improved methods and systems for managing such accounts and the processing of claims for reimbursement from such accounts.

### BRIEF SUMMARY OF THE INVENTION

Embodiments of the invention thus provide methods and systems for processing a request for reimbursement of an expense incurred from a service provider by a customer. A first electronic packet that comprises the reimbursement request is received at a coordination system. The reimbursement request comprises an identification of the customer, an identification of a reimbursement-account provider, and a reimbursement amount. A second electronic packet is transmitted from the coordination system to a provider platform maintained by or on behalf of the reimbursement-account provider. The second electronic packet comprises the identification of the customer, the reimbursement amount, and information related to a service provided for the customer by the service provider. A third electronic packet is received from the provider platform at the coordination system. The third electronic packet comprises an approval of the reimbursement request. Instructions are issued with the coordination system to effect payment for the service by the reimbursement-account provider.

There are various ways in which payment for the service may be effected. For instance, payment could be made to the customer or could be made to the service provider. A check payable to one of the customer and the service provider may be printed. In other embodiments, instructions may be issued to a financial institution to perform an electronic transfer of funds from an account of the reimbursement-account provider to an account of one of the customer and the service provider.

The first electronic packet may sometimes further comprise an electronic document providing particulars of the service provided for the customer by the service provider. For instance, the electronic document could comprise an electronic receipt or invoice. A copy of the electronic document may also be stored. In such instances, the coordination system may receive a request for a copy of the electronic document, which it provides by retrieving the stored copy and transmitting a copy of the retrieved copy.

In one embodiment, the coordination system receives a fourth electronic packet that comprises a second reimbursement request. The second reimbursement request comprises an identification of a second customer, an identification of a second reimbursement-account provider, and a second reimbursement amount. A fifth electronic packet is transmitted from the coordination system to a second provider platform maintained by or on behalf of the second reimbursement-account provider. The fifth electronic packet comprises the identification of the second customer, the second reimbursement amount, and information related to a second service provided for the customer by a second service provider. A sixth electronic packet is received from the second provider platform at the coordination system. The sixth electronic packet comprises a denial of the second reimbursement request.

The first electronic packet may be received over a public communications network from the customer. In one embodiment, a fourth electronic packet is received at the coordination system. This electronic packet comprises the identification of the customer, the identification of the reimbursement-account provider, an identification of a reimbursement account maintained by the reimbursement-account provider, and a specification of a payment preference. A coordination account is initiated that associates the identification of the customer with the identification of the reimbursement-account provider and that maintains the identification of the reimbursement account and the specification of the payment preference. A balance available to the customer in a reimbursement account maintained by the reimbursement-account provider may be maintained on behalf of the customer.

The methods of the present invention may be embodied in a system having a communications device, a processor, a storage device, and a memory coupled with the processor. The memory comprises a computer-readable medium having a computer-readable program embodied therein for directing operation of the system. The computer-readable program includes instructions for operating the system in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram illustrating an architecture within which methods of the invention may be performed;

FIG. 2 is a schematic diagram of a computational device on which methods of the invention may be embodied;

FIG. 3A is a flow diagram illustrating methods for processing a claim in accordance with embodiments of the invention;

FIGS. 3B-3E provide examples of screens that may be presented to a user in implementing the methods of FIG. 3A;

FIG. 4A is a flow diagram illustrating methods of managing claim information for a user in accordance with embodiments of the invention; and

FIG. 4B is an example of a screen that may be presented to a user in implementing the methods of FIG. 4A.

### DETAILED DESCRIPTION OF THE INVENTION

Embodiments of the invention provide methods and systems for the adjudication and processing of claims for reimbursement from reimbursement accounts. As used herein, a “reimbursement account” is an account to which periodic payments are made by a customer, usually as deductions from a paycheck, with the finds in the account being available for reimbursement for defined categories or types of expenses. In some instances, the payments made to the reimbursement account may be sheltered from income tax. In some instances, advances on the reimbursement account may be permitted. Such advances usually function in arrangements where an employee agrees to contribute a certain total amount to the account with periodic payments over a defined time period such as a year. The employee may be permitted to be reimbursed for a qualifying expense on an advance basis, provided the expense was incurred during the defined time period and the reimbursement is for an amount less that the total contribution amount.

Examples of reimbursement accounts include health savings accounts (“HSAs”), flexible spending accounts (“FSAs”), health-reimbursement accounts (“HRAs”), dependent-care reimbursement accounts (“DCRAs”), transportation reimbursement accounts (“TRAs”), parking reimbursement accounts (“PRAs”), and the like. In many instances, a customer may maintain multiple such accounts at any given time. Often, the customer is an employee of an organization that has established a relationship with providers for the reimbursement accounts, with the customer being given no option which provider to use.

The following example is provided for purposes of illustration of the type of arrangement that might exist and of the relationship between the customer and the providers. A customer is hired by an organization and provided with benefits information that describes various vacation policies, group insurance plans, personnel policies, “flex plans,” and the like. The group insurance plans may include health insurance, dental insurance, prescription-drug coverage, life insurance, long-term-care insurance, etc., each of which may be provided by a different provider that has a contractual relationship with the employer. The “flex plans” may include the ability to contribute pre-tax income to reimbursement accounts like those described above, with the employer offering HSAs, FSAs, TRAs, and PRAs in this example. The employee customer decides to participate in the various insurance plans, having been notified that a portion of the premiums for such plans will be deducted from his bimonthly paycheck and will be added to a premium contribution by the employer, who will remit payment to the insurer. The employee customer also decides to participate in the HSA and TRA reimbursement-account plans, having been similarly notified that his yearly contribution to each of those plans will be divided into 24 equal amounts that will be deducted from his bimonthly paycheck; the employer will remit these payments to the providers of these accounts, which in this example are different for different accounts.

The new employee completes a number of forms, providing information required for participation in these insurance and reimbursement-account plans, which are reviewed by the employer personnel to be made available to the providers. Over time, the employee receives paychecks in which the relevant amounts have been deducted to make insurance premium payments and to fund the reimbursement accounts. This employee had a similar arrangement at his previous employer, but had insurance provided by different providers and had reimbursement accounts maintained by different providers than is the case with his current employer. Furthermore, his previous employer had changed providers the previous year as a result of complaints from employees of difficulties interacting with the original providers.

Embodiments of the invention provide an intermediary that acts as an interface between the customer employee and the providers. In some instances, the intermediary may also act as an interface between the employer and the providers. For instance, when the employer receives the customer's completed forms in the example described above, it might advantageously provide all the forms to the intermediary, which ensures compliance with the requirements of each individual provider and attends to transferring the relevant information to the providers to initiate services. In other embodiments, the employer could transfer the completed forms directly to the providers as is generally performed with conventional arrangements.

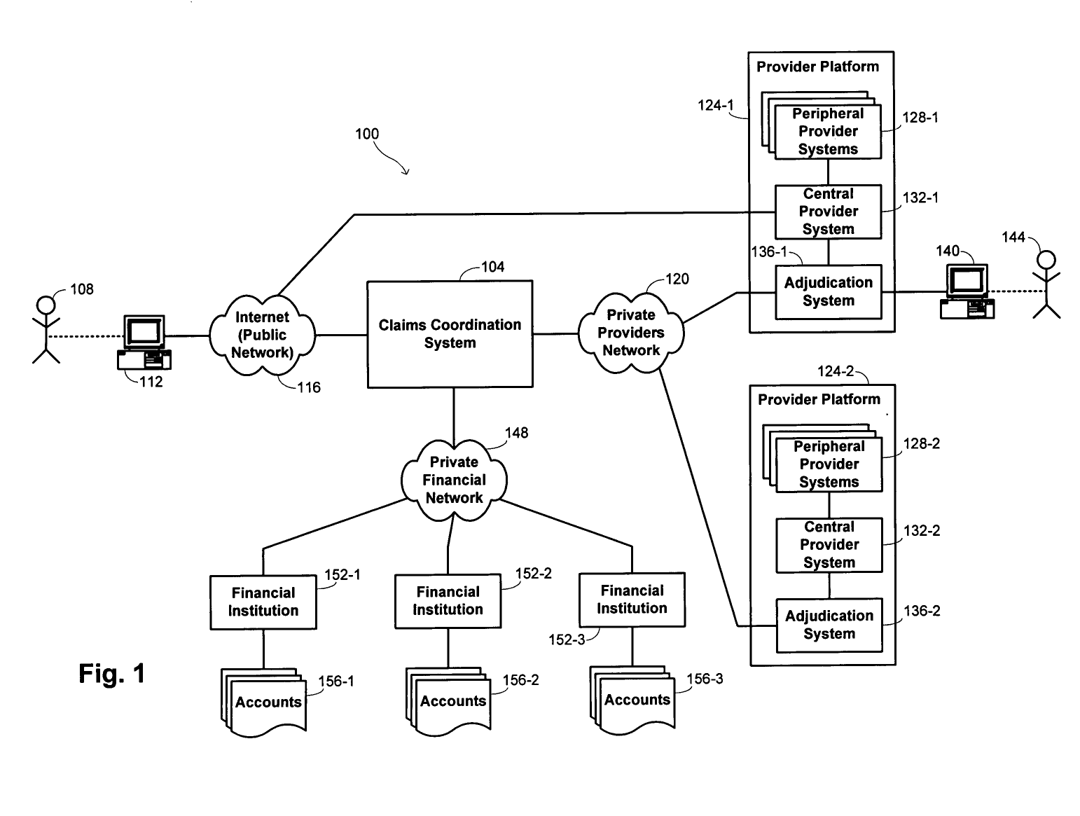

The role of the intermediary is illustrated with a schematic illustration of an architecture 100 in which it operates in FIG. 1. The intermediary provides a claims coordination system 104 that acts as a primary interface with customers 108 in processing claims and providing historical and other account information to customers 108. Interaction with the claims coordination system 104 by customers 108 may be made through a public network like the Internet 116, which is accessed by the customers 108 through appropriate computational devices 112 that may include personal computers, laptops, personal digital assistants, cellular telephones, and the like.

The claims coordination system 104 is also interfaced with various provider platforms 124 through one or more provider networks 120. Each provider platform 124 may comprise an adjudication system 136 that aids an adjudicator 144 in evaluating claims and a central provider system 132 that coordinates various functionalities of the provider platform 124, including those of the adjudication system 136 and various peripheral provider systems 128. The adjudicator 144 interacts with the adjudication system through a computational device 140. One benefit of the intermediary functionality of the claims coordination system 104 is that it may be in communication with numerous provider platforms 124. Referring again to the example described above, some of the provider platforms 124 may be controlled by providers who maintained reimbursement accounts on behalf of the customer employee, both at the time he left his former job and earlier, when different providers were used. The employee customer's interaction with the claims coordination system 104 may thus be substantially uninterrupted over this entire period of time, notwithstanding the change in providers made by his former employer and notwithstanding his change in employment. When the claims coordination system 104 maintains historical records as a result of that interaction, it accordingly has information that may continue to be accessed by the customer employee despite these reasons for provider changes.

The illustration of the architecture 100 in FIG. 1 also demonstrates that there are different ways in which interactions with the provider platforms 124 may be effected. For example, the drawing shows that provider platform 124-1 has a connection with the Internet 116 through its central provider system 132-1. This provides an alternative communications pathway for the claims coordination system 104 to interact with the provider platform 124-1, particularly for the exchange of nonconfidential information that may not be directly related to claims adjudication. It also provides a communications pathway for direct interaction between the customer 108 and the provider, which may be useful for the customer 108 to obtain additional information regarding the provider that is not directly related to claims processing.

The claims coordination system 104 may also be in communication with one or more financial institutions 152 through one or more private financial networks 148. Each of the financial institutions maintains financial accounts 156, which may hold funds on behalf of customers 108 and/or on behalf of providers. Communications between the claims coordination system 104 and the financial institutions 152 permit instructions to be transmitted to effect transfers of funds in providing reimbursements.

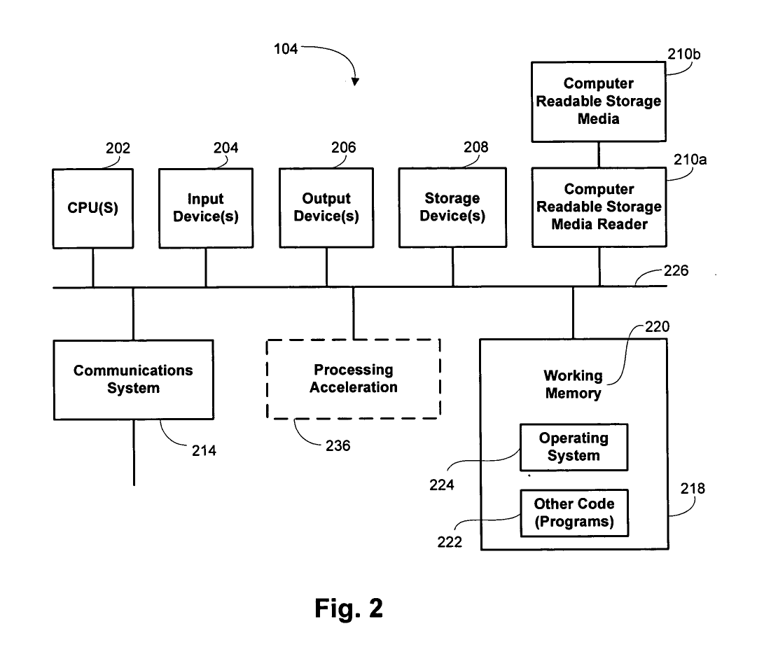

FIG. 2 provides a schematic illustration of a physical structure that may be comprised by the claims coordination system 104 to implement embodiments of the invention. FIG. 2 broadly illustrates how individual system elements may be implemented in a separated or more integrated manner. The claims coordination system 104 is shown comprised of hardware elements that are electrically coupled via bus 226, including a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged over the architecture 100 described in connection with FIG. 1.

The claims coordination system 104 also comprises software elements, shown as being currently located within working memory 220, including an operating system 224 and other code 222, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

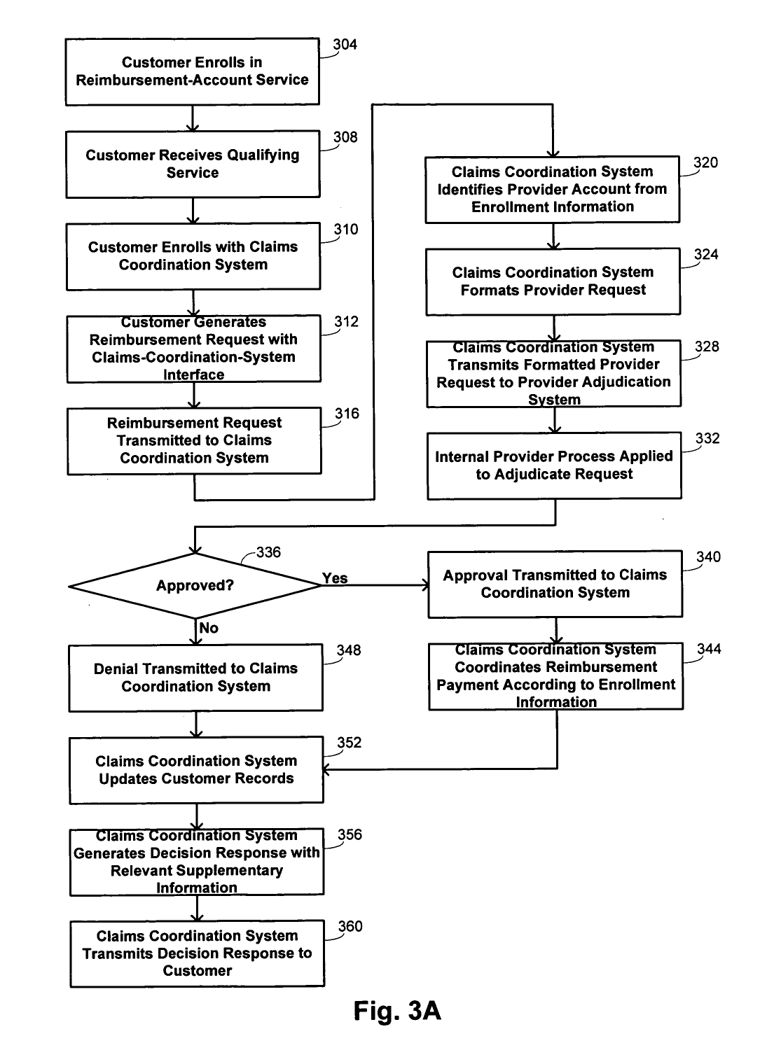

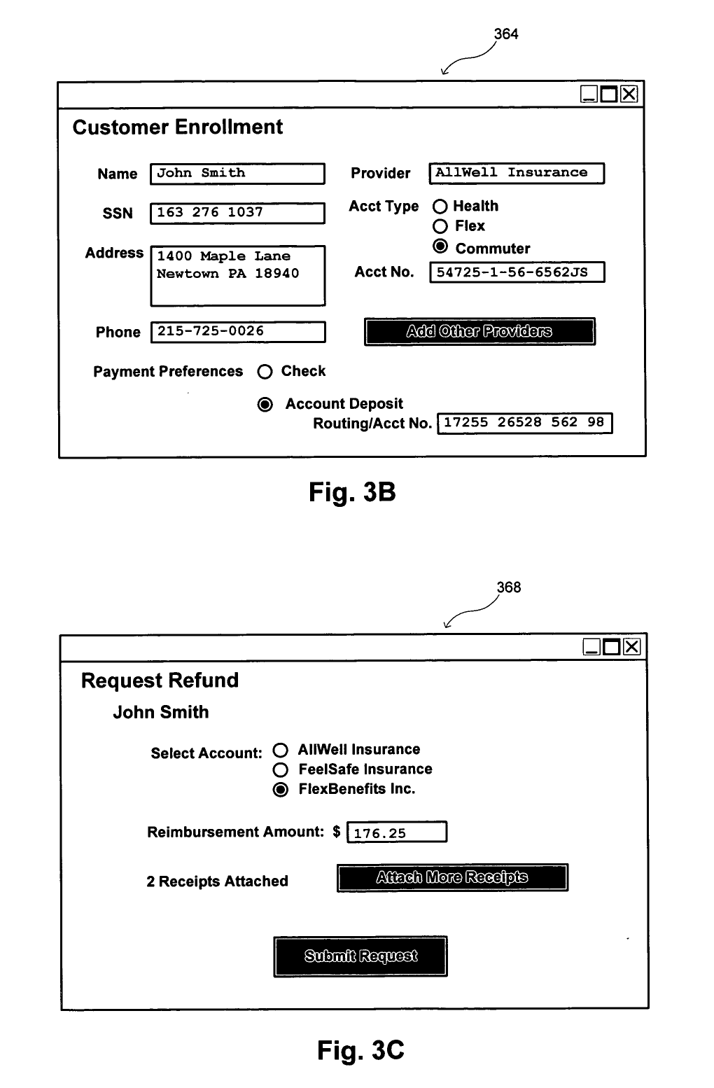

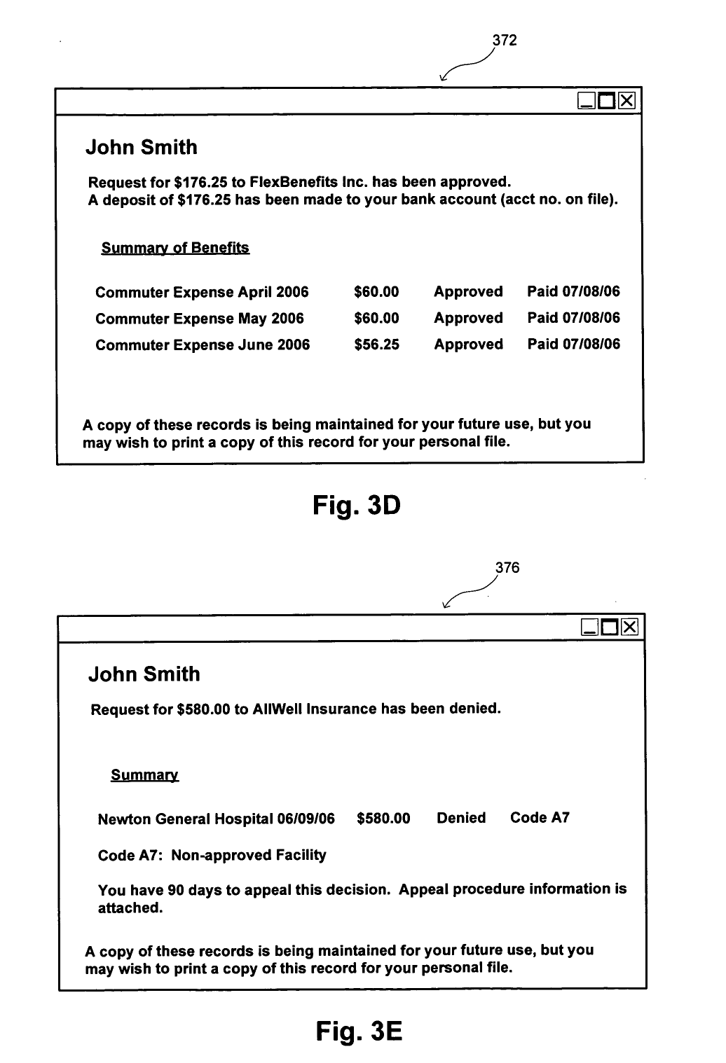

Methods by which a customer may use the interface with the claims coordination system 104 and have a claim processed and adjudicated are illustrated with the flow diagram of FIG. 3A. In discussing this drawing, reference is sometimes made to the structural elements in the architecture of FIG. 1 and to examples of screens that may be presented on the customer's computational device 112, illustrated in FIGS. 3B-3E. Thus, after a customer 108 completes enrollment procedures as indicated at block 304 to establish a reimbursement account, the customer 108 receives some kind of qualifying service at block 308. The specific nature of the qualifying service may depend on the nature of the reimbursement account, but could include such services as medical treatments, surgical procedures, dental treatments, optometry examinations, orthodontic services, commuter services, parking services, etc. The customer 108 makes payment for the service and receives a receipt, which is either conveyed by the provider in electronic form or converted to electronic form. For example, if the provider conveys a paper receipt for the service, it may be scanned into a suitable electronic format as a PDF or equivalent file. In alternative embodiments, the customer may receive a bill or invoice and make payment at a later date, in which case the bill or invoice may be used in lieu of a receipt in generating and coordinating reimbursement requests.

If the customer 108 has not previously done so, he may enroll with the claims coordination system at block 310. This may be done with an interface like the one shown in FIG. 3B, which may also be used by the customer 108 to maintain current information with the system. For instance, the enrollment interface may request such information as the name of the customer, his social security number or other government-issued identification string, his address, his telephone number, and the like. Information is provided to identify the provider that maintains a particular reimbursement account, with particulars of the account being specified to identify the type of account, its account number, and the like. A facility may be provided to add or delete providers as the customer's circumstances change over time. The manner in which reimbursement is to be made may also be defined by the customer 108, including such options as mailing a check to the customer 108, directly depositing the reimbursement amounts into a specified account of the customer's, and the like. In those instances where direct deposit is to be used, the customer may specify the account by providing such information as a bank identification number (“BIN”) and account number, or by providing some other combination of information that identifies the account. In some instances, flexibility may be provided so that reimbursements from different providers are made differently, such as by having some be made by check while others are made as direct deposits or by having direct deposits made to different accounts.

To initiate procedures for obtaining a reimbursement for his qualifying expenses, the customer generates a reimbursement request by interfacing with the claims coordination system at block 312. An example of a screen 368 that may be used in generating such a request is illustrated in FIG. 3C, which shows that a personalized menu may be provided to the customer 108 to permit selection of any of the providers that have been associated with the customer by the claims coordination system 104. The exemplary screen 368 shows an arrangement in which radio buttons may be provided for selection of the provider with fields to define the reimbursement amount being requested, and a mechanism for attaching the electronic receipts supporting the request. Other equivalent arrangements may be used in other embodiments. In addition, the claims coordination system 104 may include programming that tailors templates according to type of reimbursement and identity of provider to ensure that the request may be tailored to have the required information. Once the customer 108 has provided the pertinent information and attached whatever supporting documentation is required, he may submit the request, such as by activating the “Submit Request” button shown in FIG. 3C to transmit the completed request to the claims coordination system 104.

The claims coordination system 104 responds by cross-referencing the enrollment information at block 320 to identify the specific account maintained by the identified provider for the individual customer 108. This information is combined with information extracted from the request and formatted in accordance with criteria established by the provider at block 324. This formatted provider request thus includes the information anticipated to be relevant for adjudication of the claim and includes the receipts or other supporting documentation appended by the customer 108. The formatted provider request is transmitted to the provider adjudication system 136 at block 328 and is subject to internal reviews by the provider. There are many different types of review that may be performed by different providers, ranging from very modest reviews that are completely automated to detailed considerations by a human adjudicator 144. In cases where a human adjudicator 144 is involved, she may interact with the adjudication system 136 using her own computational device 140 in the form of a personal computer, laptop, personal digital assistant, cellular telephone, or the like. Such interaction may involve issuing requests for additional information that may be stored by the peripheral provider systems 128, such as historical information relating to past claims made by the customer 108, information regarding the practitioner who provided the service underlying the claim, and the like.

Whether the adjudication of the claim is automatic or has a significant human consideration, a decision is ultimately reached whether to approve or deny the claim. If the claim is approved, as checked at block 336, a notification to that effect is returned by the adjudication system 136 to the claims coordination system 144. The claims coordination system 144 responds to receipt of the approval by determining what form of reimbursement the customer 108 prefers. Such a determination is generally made with reference to the enrollment information and may be defined by a global preference specified by the customer 108 or defined by a particular preference for reimbursements from the specific provider. In either case, the claims coordination system 104 coordinates the reimbursement at block 344. This may include transmitting instructions to a financial institution 152 that maintains an account on behalf of the provider to instruct the financial institution 152 to transfer funds electronically to an account specified by the customer 108. This account information may also be drawn from the enrollment information, again either as a result of a global or individualized specification, and included with the instructions transmitted to the financial institution 152. Alternatively, a check may be printed for mailing to the customer 108. The actual printing might be performed by the financial institution 152 upon instructions from the claims coordination system 104 or could be performed at the intermediary with authorization from the provider to perform such a function. In still other instances, a return transmission could be made to the provider platform 124 indicating the customer's preference for payment by check so that the check may be generated and mailed by the provider.

If the claim is instead denied, a denial is transmitted to the claims coordination system 104 from the adjudication system 136 at block 348. Fewer actions are generally performed with a denial since arrangements need not be made at that time for payment to be made to the customer 108.

Whether the claim is approved or denied, the claims coordination system 104 updates records maintained on behalf of the customer 108 at block 352. Such an update adds to existing records that are associated with the customer 108 by the claims coordination system 104, thereby accumulating over time a complete local record of claim activity by the customer, even when providers change for various reasons. At block 356, the claims coordination system 104 generates a decision response in a format intended to be viewed by the customer 108. The specific content of the decision response may thus be tailored with supplementary information relevant to the decision, in addition to simply reporting the decision to the customer 108. The decision response is accordingly transmitted to the customer at block 360.

FIGS. 3D and 3E show examples of decision responses as they may appear to the customer 108 after transmission at block 360, with FIG. 3D showing an example 372 of an approval response and FIG. 3E showing an example 376 of a denial response. The approval response 372 may include such information as a summary of the reimbursement request and how the reimbursement was effected, i.e. with payment by check, with payment by direct deposit, or some other payment mechanism. In addition, a breakdown of how the total payment was determined may be included, such as with a specification of the separate amounts associated with each of the receipts submitted with the reimbursement request.

The denial response 376 may similarly include a summary of the reimbursement request and a statement that it has been denied. A breakdown of each portion of the reimbursement request may also be included, with an indication for each portion why the reimbursement request was denied. Supplementary information that may usefully be included with such a denial response includes a description of procedures that may be initiated to appeal the decision.

It will be recognized that in some instances the decision response may be a hybrid response to reflect those occasions in which a portion of a reimbursement request is approved and a portion is denied. In such cases, information similar to that illustrated with FIGS. 3D and 3E may be included, providing a summary of the reimbursement request and a breakdown of which portions of the request were approved, which were denied, and the basis for denial of those that were denied.

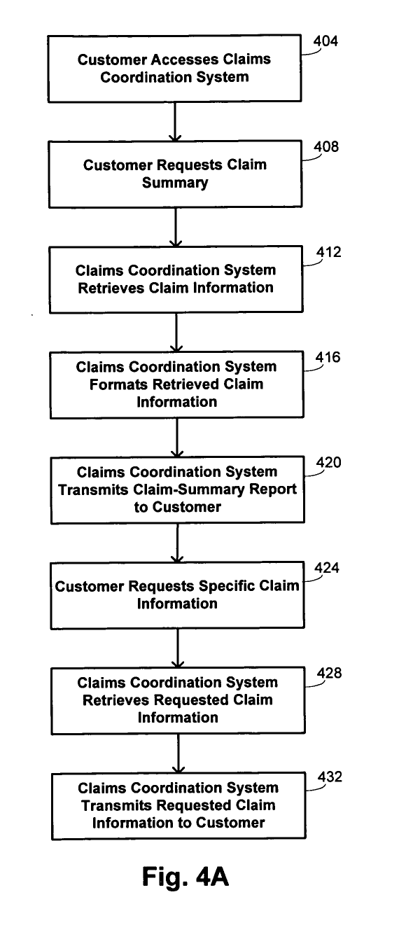

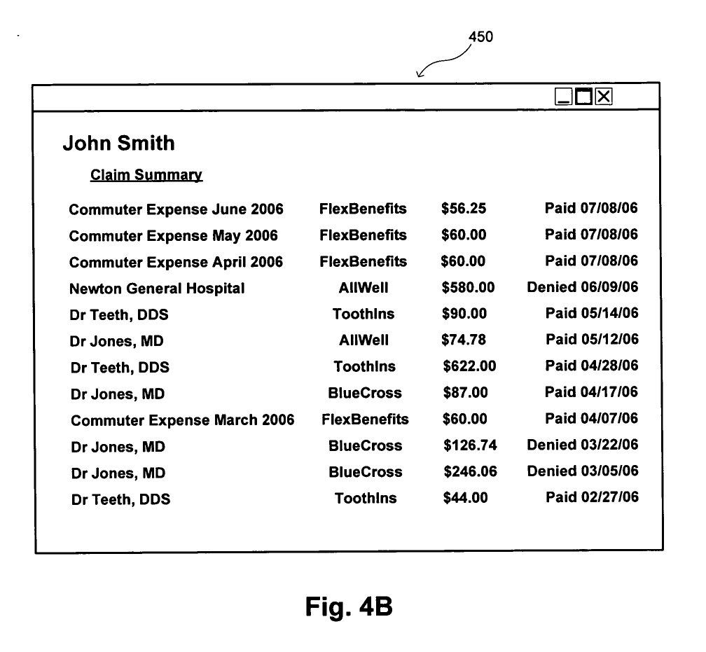

FIG. 4A provides a flow diagram illustrating a process for accessing historical information that has been stored by the claims coordination system 104, as might be desired by a customer 108 for any of a variety of reasons. At block 404, the customer 108 accesses the claims coordination system 104 through an interface as illustrated in FIG. 1, and uses the interface to submit a request for a claims summary at block 408. The request may define limiting criteria, such as limiting the summary to specific dates, to a date range, to specific providers, to specific types of claims, and the like. The claims coordination system 104 retrieves the claim information at block 412 by applying the limiting criteria as filters, and formats the retrieved claim information at block 416 for presentation to the customer 108.

An example of a formatted summary report 430 that may be transmitted to the customer at block 420 is illustrated in FIG. 4B. In this instance, such summary information as an identification of the type of each reimbursement request, the provider it was submitted to, its amount, the decision, and the date of the decision are provided, but in other embodiments other summary information may be provided. A mechanism may be provided to drill down to more detailed information, such as by including hyperlinks on the summary report 450. More specific information for a particular claim may be requested at block 424 of FIG. 4A by activating the hyperlink, causing the claims coordination system 104 to retrieve the more detailed claim information at block 128 and to transmit it to the customer 108 at block 432. Such more detailed information may include a copy of the original reimbursement request completed by the customer 108, as well as a copy of all receipts and other documentation attached to the original reimbursement request.

The customer 108 is thus able to retrieve and otherwise manage historical information that is personal to him or her, without regards to how providers may have changed over time. While certain functionality of the claims coordination system 104 has been described in some detail, additional functionality may be provided in various embodiments to enhance the service available to the customer 108. For instance, funding levels within each of the customer's reimbursement accounts may be monitored by the system, permitting the customer 108 easily to determine finding levels when desired. In addition, while much of the foregoing discussion has focused on reimbursements that are paid to the customer 104, in other instances the reimbursements may be paid to the service provider who provided the qualifying service to the customer 108. Such embodiments are useful where the service provider provided the qualifying service without charge as a convenience to the customer, and may include payment by check, payment by electronic funds transfer, or by any other payment mechanism available for making payments to the customer 108 directly. Facilities may be provided for communicating status information to the customer 108 while a reimbursement request is being processed.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of processing a reimbursement request for reimbursement of an expense incurred from a service provider by a customer, the method comprising:
receiving, at a coordination system, a first electronic packet that comprises the reimbursement request, the reimbursement request comprising an identification of the customer, an identification of a reimbursement-account provider, and a reimbursement amount;
transmitting, from the coordination system to a provider platform maintained by or on behalf of the reimbursement-account provider, a second electronic packet that comprises the identification of the customer, the reimbursement amount, and information related to a service provided for the customer by the service provider;
receiving, from the provider platform at the coordination system, a third electronic packet that comprises an approval of the reimbursement request; and
issuing, with the coordination system, instructions to effect payment for the service by the reimbursement-account provider.

2. The method recited in claim 1 wherein issuing instructions to effect payment for the service comprises issuing instructions to effect payment to the customer.

3. The method recited in claim 1 wherein issuing instructions to effect payment for the service comprises issuing instructions to effect payment to the service provider.

4. The method recited in claim 1 wherein issuing instructions to effect payment for the service comprises issuing instructions to print a check payable to one of the customer and the service provider.

5. The method recited in claim 1 wherein issuing instructions to effect payment for the service comprises issuing instructions to a financial institution to perform an electronic transfer of funds from an account of the reimbursement-account provider to an account of one of the customer and the service provider.

6. The method recited in claim 1 wherein the first electronic packet further comprises an electronic document providing particulars of the service provided for the customer by the service provider.

7. The method recited in claim 6 wherein the electronic document comprises an electronic receipt or invoice.

8. The method recited in claim 6 further comprising storing a copy of the electronic document.

9. The method recited in claim 8 further comprising:
receiving, at the coordination system, a request for a copy of the electronic document;
retrieving, with the coordination system, the stored copy of the electronic document; and
transmitting, from the coordination system, a copy of the retrieved copy of the electronic document.

10. The method recited in claim 1 further comprising:
receiving, at the coordination system, a fourth electronic packet that comprises a second reimbursement request, the second reimbursement request comprising an identification of a second customer, an identification of a second reimbursement-account provider, and a second reimbursement amount;
transmitting, from the coordination system to a second provider platform maintained by or on behalf of the second reimbursement-account provider, a fifth electronic packet that comprises the identification of the second customer, the second reimbursement amount, and information related to a second service provided for the second customer by a second service provider; and
receiving, from the second provider platform at the coordination system, a sixth electronic packet that comprises a denial of the second reimbursement request.

11. The method recited in claim 1 wherein receiving the first electronic packet comprises receiving the first electronic packet over a public communications network from the customer.

12. The method recited in claim 1 further comprising:
receiving, at the coordination system, a fourth electronic packet that comprises the identification of the customer, the identification of the reimbursement-account provider, an identification of a reimbursement account maintained by the reimbursement-account provider, and a specification of a payment preference; and
initializing a coordination account that associates the identification of the customer with the identification of the reimbursement-account provider and that maintains the identification of the reimbursement account and the specification of the payment preference.

13. The method recited in claim 1 further comprising monitoring, with the coordination system, a balance available to the customer in a reimbursement account maintained by the reimbursement-account provider on behalf of the customer.

14. A method of managing reimbursement requests for reimbursement of expenses incurred from service providers by a customer, the method comprising:
receiving, at a coordination system from the customer over a public communications network, a first electronic packet that comprises an identification of the customer, an identification of at least one reimbursement-account provider, an identification of a reimbursement account maintained by the at least one reimbursement-account provider, and a specification of a payment preference, wherein the payment preference is selected from the group consisting of preparing a check payable to the customer and performing an electronic transfer of funds to an account maintained on behalf of the customer;
initializing a coordination account that associates the identification of the customer with the identification of the at least one reimbursement-account provider and that maintains the identification of the reimbursement account and the specification of the payment preference;
receiving, at the coordination system from the customer over the public communications network, a second electronic packet that comprises a first reimbursement request, the first reimbursement request comprising the identification of the customer, an identification of one of the at least one reimbursement-account provider, a first reimbursement amount, and a first electronic receipt itemizing details of one or more services provided for the customer by one or more of the service providers;
transmitting, from the coordination system to a first provider platform maintained by or on behalf of the one of the at least one reimbursement-account provider, a third electronic packet that comprises the identification of the customer, the first reimbursement amount, and the first electronic receipt;
storing, with the coordination system, a copy of the first electronic receipt and associating the stored copy with the coordination account associated with the customer;
receiving, from the first provider platform at the coordination system, a fourth electronic packet that comprise an approval of the first reimbursement request;
issuing, with the coordination system, instructions to effect payment for the service to the customer by the one of the at least one reimbursement-account provider according to the specification of the payment preference.

15. The method recited in claim 14 further comprising:
receiving, at the coordination system from the customer over the public communications network, a fifth electronic packet that comprises a second reimbursement request, the second reimbursement request comprising the identification of the customer, an identification of a second of the at least one reimbursement-account provider, a second reimbursement, and a second electronic receipt itemizing details of one or more services provided for the customer by one or more of the service providers;
transmitting, from the coordination system to a second provider platform maintained by or on behalf of the second of the at least one reimbursement-account provider, a sixth electronic packet that comprises the identification of the customer, the second reimbursement amount, and the second electronic receipt;
storing, with the coordination system, a copy of the second electronic receipt and associating the stored copy of the second electronic receipt with the coordination account associated with the customer; and
receiving, from the second provider platform at the coordination system, a seventh electronic packet that comprises a decision on the second reimbursement request, the decision being selected from the group consisting of an approval and a denial.

16. The method recited in claim 15 further comprising:
receiving, at the coordination system from the customer over the public communications network, a request for copies of the first and second electronic receipts;
retrieving, with the coordination system, the stored copy of the first electronic receipt and the stored copy of the second electronic receipt; and
transmitting, from the coordination system to the customer over the public communications network, copies of the retrieved copy of the first electronic receipt and of the retrieved copy of the second electronic receipt.

17. A system for processing a reimbursement request for reimbursement of an expense incurred from a service provider by a customer, the system comprising:
a communications device;
a processor;
a storage device; and
a memory coupled with the processor, the memory comprising a computer-readable medium having a computer-readable program embodied therein for directing operation of the system to process the reimbursement request, the computer-readable program including:
instructions for receiving, with the communications system, a first electronic packet that comprises the reimbursement request, the reimbursement request comprising an identification of the customer, an identification of a reimbursement-account provider, and a reimbursement amount;
instructions for transmitting, with the communications system to a provider platform maintained by or on behalf of the reimbursement-account provider, a second electronic packet that comprises the identification of the customer, the reimbursement amount, and information related to a service provided for the customer by the service provider;
instructions for receiving, with the communications system from the provider platform, a third electronic packet that comprises an approval of the reimbursement request; and
instructions for effecting payment for the service by the reimbursement-account provider.

18. The system recited in claim 17 wherein the instructions for effecting payment for the service comprise instructions for effecting payment to the customer.

19. The system recited in claim 17 wherein the instructions for effecting payment for the service comprise instructions for effecting payment to the service provider.

20. The system recited in claim 17 wherein the instructions for effecting payment for the service comprise instructions to print a check payable to one of the customer and the service provider.

21. The system recited in claim 17 wherein the instructions for effecting payment for the service comprise instructions to a financial institution to perform an electronic transfer of funds from an account of the reimbursement-account provider to an account of one of the customer and the service provider.

22. The system recited in claim 17 wherein the first electronic packet further comprises an electronic document providing particulars of the service provided for the customer by the service provider.

23. The system recited in claim 22 wherein the electronic document comprises an electronic receipt or invoice.

24. The system recited in claim 22 wherein the computer-readable program further includes instructions for storing a copy of the electronic document on the storage device.

25. The system recited in claim 24 wherein the computer-readable program further includes:
instructions for receiving, with the communications system, a request for a copy of the electronic document;
instructions for retrieving, from the storage device, the stored copy of the electronic document; and
instructions for transmitting, with the communications system, a copy of the retrieved copy of the electronic document.

26. The system recited in claim 17 wherein the computer-readable program further includes:
instructions for receiving, with the communications system, a fourth electronic packet that comprises a second reimbursement request, the second reimbursement request comprising an identification of a second customer, an identification of a second reimbursement-account provider, and a second reimbursement amount;
instructions for transmitting, with the communications system to a second provider platform maintained by or on behalf of the second reimbursement-account provider, a fifth electronic packet that comprises the identification of the second customer, the second reimbursement amount, and information related to a second service provided for the second customer by a second service provider; and
instructions for receiving, with the communications system from the second provider platform, a sixth electronic packet that comprises a denial of the second reimbursement request.

27. The system recited in claim 17 wherein the communications system is interfaced with a public communications network.

28. The system recited in claim 17 wherein the computer-readable program further includes:
instructions for receiving, with the communications system, a fourth electronic packet that comprises the identification of the customer, the identification of the reimbursement-account provider, an identification of a reimbursement account maintained by the reimbursement-account provider, and a specification of a payment preference; and
instructions for initializing a coordination account that associates the identification of the customer with the identification of the reimbursement-account provider and that maintains the identification of the reimbursement account and the specification of the payment preference.

29. The system recited in claim 17 wherein the computer-readable program further comprises instructions for monitoring a balance available to the customer in a reimbursement account maintained by the reimbursement-account provider on behalf of the customer.
